(19) United States
(12) Patent Application Publication
(10) Pub. No.: US 2025/0269637 A1
(43) Pub. Date: Aug. 28, 2025

(54) SYSTEMS AND METHODS FOR ELECTRODE DELAMINATION BY INDUCTION HEATING

(71) Applicant: UCHICAGO ARGONNE, LLC, Chicago, IL (US)

(72) Inventors: Ozgenur KAHVECIOGLU, Naperville, IL (US); Bryant J. POLZIN, Deerfield, IL (US); Beihai MA, Naperville, IL (US)

(73) Assignee: UCHICAGO ARGONNE, LLC, Chicago, IL (US)

(21) Appl. No.: 19/067,610

(22) Filed: Feb. 28, 2025

Related U.S. Application Data
(63) Continuation-in-part of application No. 18/590,466, filed on Feb. 28, 2024.

(51) Int. Cl. B32B 43/00; H01M 10/54

(52) U.S. Cl. CPC B32B 43/006; H01M 10/54; B32B 2457/10

(57) ABSTRACT

A method includes providing a feedstock. The feedstock includes a first active material disposed on a first current collector and a second active material disposed on a second current collector. The method includes heating, by induction, the feedstock above a first temperature for a first period of time. The method includes delaminating the first active material from the first current collector during the first period of time. The method includes heating, by induction, the feedstock above a second temperature, which is greater than the first temperature, for a second period of time subsequent to the first period of time. The method includes delaminating the second active material from the second current collector during the second period of time.

### CROSS-REFERENCE TO RELATED APPLICATIONS

This application is a continuation-in-part of U.S. application Ser. No. 18/590,466 filed Feb. 28, 2024, the contents of which are incorporated herein by reference in their entirety.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to the recycling of batteries.

### BACKGROUND

Lithium-ion batteries (LIBs) are widely applied in portable electronics and electric vehicles.

### SUMMARY

One aspect of the present disclosure is directed to a method. The method includes providing a feedstock. The feedstock includes a first active material disposed on a first current collector and a second active material disposed on a second current collector. The method includes heating, by induction, the feedstock above a first temperature for a first period of time. The method includes delaminating the first active material from the first current collector during the first period of time. The method includes heating, by induction, the feedstock above a second temperature, which is greater than the first temperature, for a second period of time subsequent to the first period of time. The method includes delaminating the second active material from the second current collector during the second period of time.

Another aspect of the present disclosure is directed to a system. The system includes a reactor. The reactor includes a conveyor disposed in a housing. The system includes a first port coupled with the housing and configured to receive a feedstock. The feedstock includes a first active material disposed on a first current collector and a second active material disposed on a second current collector. The system includes a first induction heater disposed around the housing downstream of the first port. The system includes a second induction heater disposed around the housing downstream of the first induction heater.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through the use of the accompanying drawings.

FIG. 1 is a flow chart of a method for harvesting active material from electrodes, according to an example implementation.

FIG. 2 is a photograph of shredded anode active materials after being subjected to inductive heating, according to an example implementation.

FIG. 3A is a graph showing average discharge capacity versus cycle of anode graphite regenerated with the instant continuous method, according to an example implementation.

FIG. 3B is a graph showing average charge capacity versus cycle of anode graphite regenerated with the instant continuous method, according to an example implementation.

FIG. 4 is a schematic diagram of a continuous delamination device for spent battery active materials from current collectors, according to an example implementation.

FIG. 5 illustrates a schematic flow diagram of a method for recovery of active electrode materials, according to an example implementation.

FIG. 6 is an image of shredded anode strips in an alumina boat loaded into an induction heating system for processing, according to an example implementation.

FIG. 7 is an image of the remaining metal foils after delamination and removal of anode and cathode materials by an induction heating

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of, methods, apparatuses, and systems for electrode delamination by induction heating. The various concepts introduced above and discussed in greater detail below may be implemented in any of numerous ways.

Lithium-ion batteries, with the unique features of high energy density, high charging efficiency and good cycle performance, are widely applied in portable electronics and electric vehicles.

LIBs play a role in reducing carbon dioxide pollution and achieving carbon net-zero by 2050. Spent LIBs have been one of the fast-growing and largest quantities of solid waste in the world. Spent graphite anode from LIBs, accounting for 12 to 21 weight percent of those batteries, contains metals, binders, plastics, and flammable/toxic electrolytes. The vast majority of the end-of-life (EOL) lithium-ion batteries historically ended up in landfills, causing contamination of nearby soils and underground water sources. The desire to develop innovative technologies for recycling spent electrode materials through reclamation and recovery of active materials from end-of-life batteries is ever increasing.

In a typical recycling process, end-of-life (EOL) battery packs are discharged and disassembled into modules or cells, and then shredded. Disassembly commonly refers to the separation of a battery's components into its anode, separator and cathode. Disassembly is followed by electrolyte recovery and separation of active material from current collectors to remove/reclaim components including plastics, pouch material, and steel casings.

As a result, a feedstock of anode and cathode active materials still laminated with their current collectors is generated. This feedstock contains the most valuable components in a lithium-ion cell, and is often referred to as black mass. Black mass is the formless, powder-like materials collected from spent batteries excluding the metal parts (casings, foils). Black mass is a mixture of cathode powders, anode powders and the electrode formulation (carbon black, polyvinylidene fluoride (PVDF), polyacrylic acid (PAA)). It may include some copper and aluminum pieces not completely removed by such separation processes as froth flotation, and magnetic separation.

Active cathode materials include, for example, lithium nickel manganese cobalt oxide (NMC), lithium iron phosphate (LFP), lithium cobalt oxide (LCO) and lithium manganese nickel oxide (LMNO). An exemplary cathode electrode may include NMC laminated with, or otherwise overlaying aluminum foil.

Active anode materials include, for example, graphite, lithium titanium oxide, titanium metal, and silicon based anodes. An exemplary anode electrode may include graphite overlaying copper foil.

To reclaim active electrode materials with high purity for direct regeneration, electrode (cathodes and/or anodes) materials can be separated from their current collectors. There are several methods for separating electrode materials from metal foils, including solvent-based electrode recovery and thermal binder removal. However, these processes may require the use of toxic solvents and high amounts of energy, while also resulting in low peeling-off (e.g., delamination) efficiency. Solvents also may deactivate the separated components such that subsequent reactivation processes or other pretreatment steps must be employed. For example, solvent based methods often result in corrosion of the current collector foil, such that the recovered foils cannot be used as is. Rather those current collectors need to be re-melted or otherwise purified, which adds to reclamation costs. Furthermore, solvent-based processes can generate waste water which needs to be treated before being disposed to the environment. This adds another step in the overall process, which can add to cost and time.

Other methods for separating anode and cathode materials, include density separation, froth flotation, and magnetic separation. However, state of the art processes require a complex set of separation procedures to produce clean streams of material, resulting in lower recovery rates and higher costs. It is thus extremely important to develop a simple organic solution-free, scalable, and cost-effective separation process to efficiently recover high-purity electrode materials as well as other battery materials so that different concentrated feedstock are provided for further direct regeneration and recovery processes.

A need exists a direct recycling process for battery electrodes. Direct recycling refers to process wherein battery components are recycled and reused directly without modifying the chemical structures of these components. Further, the process can render recyclable material ready for direct incorporation into new product, with purities on par with virgin materials.

To reclaim active cathode materials with high purity for recycling (direct recycling optimal), cathode active materials are typically liberated from aluminum current collector foils by chemical treatment through solvent-assisted or mechanical-assisted dissolution processes, and the combined processes of chemo-thermal treatment separation of electrode materials and their current collector are needed. Several methods for separating active electrode materials from current collector metal foils, including solvent-based electrode recovery and thermal binder removal, were investigated. These processes often require the use of toxic solvents and high amounts of energy, while also resulting in low peeling-off efficiency. In both cases, solvent or thermal processes, they can damage the cathode material, therefore limiting what recycling processes could be used to recover the materials efficiently. In addition, there are some methods for separating anodes and cathodes, including gravimetric or density-based separations, froth flotation, and magnetic separation. However, current state-of-the-art requires a complex set of separation processes to produce clean streams of material, resulting in lower recovery rates and higher costs. It is thus important to develop a simple solution-free, scalable, and cost-effective separation process to efficiently recover high-purity electrode materials as well as other battery materials so that different concentrated feedstocks are provided for further direct regeneration and recovery processes.

The systems and methods of the present disclosure provide an active electrode materials delamination and recovery process utilizing induction heating. This process does not require use of solvent or any other fluids (solution-free). It is a rapid recovery process without the breakdown of the active electrode materials, highly efficient, scalable to high throughput production, and capable of recovering high purity materials from EOL LIBs. The method is useful for regenerating re-usable components, in particular high purity active cathode electrodes, from spent lithium-ion batteries, as well as recovery of active electrode materials from composite electrode scraps obtained during production of composite electrodes. The method provides a highly efficient, cost-effective, and environmentally sustainable separation process that enables direct recycling of LIB active electrode materials without using any solvents or fluids.

The systems and methods of the present disclosure provide a method for direct recycling of electrodes. Both cathodes and anodes are candidates for recycling using this method. Different cathode and anode materials may be replenished via the systems and methods of the present disclosure. For example, cathodes including either NMC, LFP, LMNO, or LCO may be recycled.

This direct recycling process provides enhanced energy-efficiency and generates less secondary pollution than hydrometallurgical or pyrometallurgical processes. The method does not require intensive energy or chemicals, avoids the destruction of spent battery materials, and directly rejuvenates degraded or spent electrode materials. For example, this recycling process can output well-defined cathode materials with high value that can be directly used to fabricate new lithium batteries. Also, the regenerated active materials generated from the method are more valuable compared to elemental products from the aforementioned pyrometallurgical and hydrometallurgical recycling methods. In summary of this point, the systems and methods of the present disclosure reduce energy consumption and greenhouse gas emissions while avoiding the use of toxic chemicals.

The systems and methods of the present disclosure continuously recover both active material and current collector foils (collectively “the electrode materials”). Active materials are separated from their underlying current collectors and both the active material and current collectors are subsequently recovered/reclaimed. Reclaimed electrode materials are reused without out further treatment in many instances, or otherwise with minimal treatments (e.g., gently grinding graphite before reuse).

Different cathode and anode materials may be replenished via the systems and methods of the present disclosure, even in the presence of common binders such as PVDF, carboxyl methyl cellulose/styrene butadiene rubber (CMC/SBR) and PAA. It is noteworthy that PVDF degrades at 180° C., such that it outgasses during inductive heat application of the process. Active anode material (e.g., graphite with 1-2 percent binder such as PVDF retains 95-99 percent of its chemical and physical characteristics after being reclaimed with the method. Recycling scrap graphite harvested by the method (and with no further treatment) performs at the same/similar cell cycling performance as the pristine graphite.

This new recycling process can output well-defined cathode materials with high value that can be directly used to fabricate new lithium batteries. Manufacturing scrap copper current foil recovered by the systems and methods of the present disclosure may be merely wiped with a mild solvent (e.g., an alcohol such as ethanol) after being separated from its overlaying active anode material. In summary of this point, the systems and methods of the present disclosure generate ready to use electrode material without the need for thermochemical treatment, but rather mild physical manipulation. Indeed, as noted supra, state of the art solvent treatment of separated battery components often results in deactivation of those components.

Also, the regenerated active materials from direct recycling might be more valuable compared to elemental products from pyrometallurgical and hydrometallurgical recycling methods. In addition, systems and methods of the present disclosure also reduce energy consumption and greenhouse gas emissions while avoiding the use of toxic chemicals.

The present disclosure provides a method for recovering current collectors (e.g., copper foil) from anodes via induction energy-induced delamination. During anode delamination by the high frequency induction heating (HFIH) process, two materials (1) graphite and (2) high purity copper foil are recovered. The recovered copper foil, which is free of copper oxide, can be used to make graphene infused advanced conductors. The method mixes and deforms the solid feedstocks without melting or external heat treating. The resulting conductivity of copper foil and wire harvested results in an increased conductivity of approximately 5 percent. Separately, upcycling of the copper foil may be used as a high-end product for other technologies than batteries.

An embodiment of the present method provides a solvent free, high throughput and induction heating (HFIH) process for the surface treatment, recycling, upcycling and reusing of spent Li-ion battery materials and delamination of battery materials from current collectors. Induction heating may be effected at frequencies ranging from 100 kHz/sec to 1000 kHz. Induction heating is utilized wherein the frequencies preferably range from 100 kHz to 500 kHz. The use of high frequency inductive radiation results in the surfaces of discrete electrode components, and the interfaces therebetween, being heated. The materials are heated for a time ranging from 10-30 seconds to 5-10 minutes. This compares to state of the art systems which heat the entire bulk of those materials for up to 300 minutes. For example, in the high frequency inductive heating (HFIH) process of the present disclosure, energy delivered by electromagnetic fields focuses at the interface between the current collector foil and electrode (cathode or anode) materials. The difference in thermal expansion coefficients of these different materials at the interface drives the delamination at that interface. For example, the large mismatch in coefficient of thermal expansion (CTE) between the graphite coating and Cu current collector foil can drive the delamination at the interface. Relatively speaking, interior regions of the active material and the current collectors are not heated to a lesser degree than the interfaces. In summary of this point, the method of the present disclosure exploits the different heating rates of the components to get preferential delamination.

Inductive energy can be applied to separate the active material from anodes and thermal energy is applied to separate the active material from cathodes. The method can be devoid of the use of any polar or nonpolar fluids.

No other changes are observed in the time frame required for the delamination process to occur. For example, full dry cell induction heating only effected the conductive copper and graphite (anode); the cathode was not affected (at least visually) and stayed intact. In cathodes of LIBs, the particle core (e.g. lithium metal oxides are transparent to inductive heating and so do not heat up. As such its physical properties are preserved.)

The process can utilize high frequency induction heating, which is a noncontact heating by electromagnetic field. Preferable frequencies range between 100 kHz and 500 kHz Hz/sec and are applied for between 10 seconds and 500 seconds. Optimal conditions for the delamination of anodes include 1.35 kW, 27 A, 200 kHz, all effected in a one-step heating process, all within 2-3 minutes. Delamination occurs within 20 seconds from the start of the heating process. When combined with inert atmosphere (i.e., a nonoxidizing atmosphere) high purity spent active materials and pristine (not-oxidized) current collector foils can be recovered.

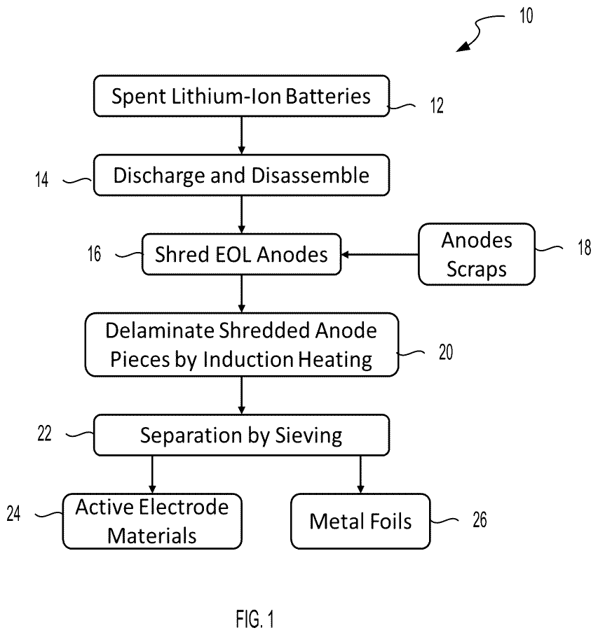

FIG. 1 is a flow chart of a method for harvesting active material from electrodes, generally designated by the numeral 10. A supply of spent lithium-ion batteries is initially provided 12. The supply is initially discharged and disassembled 14 so that primarily the electrode active material/current collector remains.

This remaining material may be subjected to shredding 16 and may be supplemented with anode scraps 18 from either virgin processing operations or other feed streams. A commonly owned battery shredding process guarantees particles being generated with certain aspect ratios that commonly owned property embodied in U.S. patent application Ser. No. 17/180,621, and incorporated herein by reference.

The resulting shredded material represents composite electrode pieces that include active material laminated or otherwise overlaid onto current collectors. For example, the composite pieces may be anode material including graphite adhered to copper foil. If cathodes are being delaminated, the composite pieces may comprise lithium metal oxide (Metal=Ni, Mn, Co, Fe, Al and etc.) on Aluminum foil. The aluminum foil may be carbon-coated or pure Al.

These composite, shredded pieces are subjected to an inductive heating process 20, which may include heating the composites to up to 250° C. for a time sufficient to cause delamination of the active material from its respective current collector. The delamination occurs as a result of the difference in thermal expansion between the active material and the metal foil. Generally, in the case of anode delamination, the active material (e.g., graphite) expands less rapidly than the underlying copper foil. It is noteworthy that other components of LIBs, such as PVDF binders, may evaporate during the heating process and are carried away by inert gas purging the system.

Depending on the extent of HFIH and other process conditions and time of heating, there may be residual PVDF in the delaminated graphite. As such, the method enables the generation of graphite already containing PVDF, thereby obviating the need for replenishing the graphite with PVDF before the graphite is integrated back into batteries.

An embodiment does not require shredding of battery components prior to the delamination step. Preferably this embodiment deals with EOL batteries or manufacturing-scrap cells, the latter of which are dry (i.e., do not contain electrolyte). For example, prior to delamination, the electrolyte is removed. At the most, disassembly of the battery is all that is required, such that the battery components are recovered nearly intact but not ground up or otherwise mutilated via shredding. This assures that current collectors are harvested intact and in their original shape and sizes. This eliminates the need to recast otherwise melted collectors prior to reincorporation into batteries.

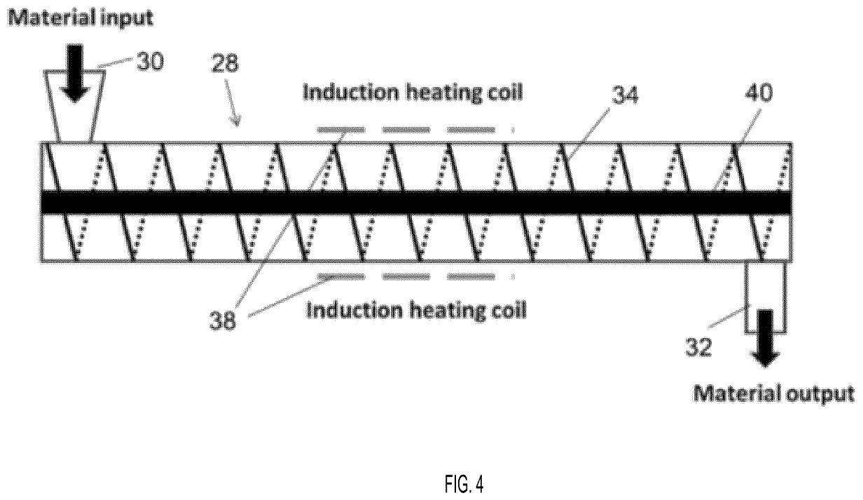

Upon completion of delamination, the two components are separated in a sieving operation 22. Sieve sizes may vary, with a preferable range of between 100 mesh (150 μm) and 10 mesh (2000 μm). The sieve(s) may be shaken or otherwise agitated to facilitate separation of the active material filtrate from the metal foil retentate. Optionally, a nitrogen purge or negative pressure may be used to optimize separation. The nitrogen purge may be applied at positive pressure at the fluid ingress port 30. Alternatively, a negative pressure (e.g., vacuum) may be applied at an egress point (see element number 32 in FIG. 4) to facilitate evacuation of liberated material from a reactor (see element number 28 in FIG. 4). The fluid ingress means may also serve as a solid material ingress port and the fluid egress means may also serve as a solid material egress port. In an embodiment of the process, the heating step includes simultaneously subjecting the pieces to inductive energy and a materials separation process selected from the group consisting of magnetism, pressure differential, floatation, sieving, and combinations thereof.

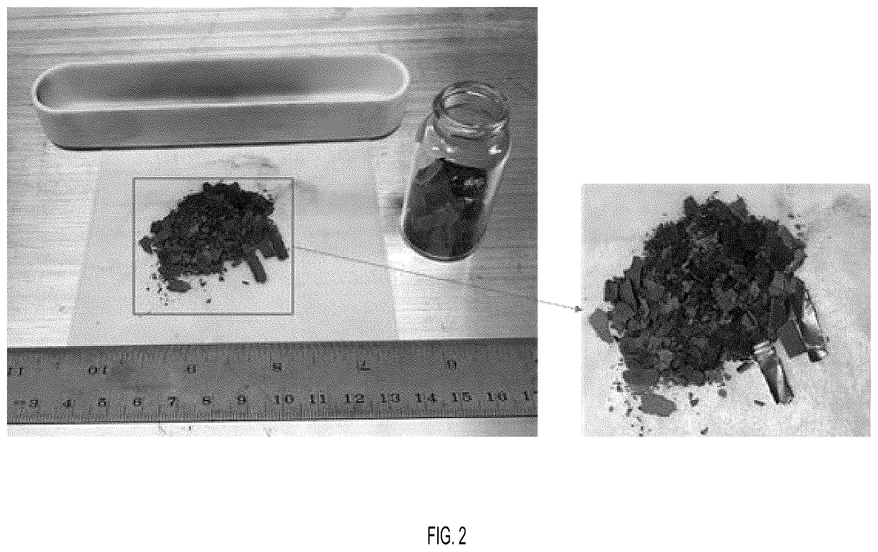

The final product, active electrode materials 24 and current collectors 26 are subsequently recovered and repurposed. Examples of such recovered material and intact current collectors are shown in FIG. 2. FIG. 2 is a photograph of shredded anode active materials recovered after being subjected to inductive heating, in accordance with features of the present disclosure. Two pieces of shredded Cu foils were placed alongside the recovered active anode material for comparison. The photograph is evidence of the method's ability to recover current collectors in a nearly intact state, which is to say, with minimal partitioning, breaking apart, or reduction of the current collector's original configurations and/or dimensions. It is noteworthy that after delamination, the materials and current collectors often need not be subjected to sieving or magnetic separation, given the intact nature of the foils so harvested. FIG. 2 shows the delaminated active anode coating materials and Cu current collector foils (mostly in glass bottle) after delamination by induction heating process. These two strips placed beside the delaminated active anode coating materials are bright and shiny indicating no surface oxidation. The delaminated active anode coating are in flake forms, which can be post processed for upcycling rejuvenation.

Methods for separation of these two components depend on the starting material, i.e., if the starting material is dry manufacturing scrap or wet end of life cells. Air classification, density separation (floatation), and mechanical separation (e.g., magnetism, sieving) to separate the graphite material and copper foil. Pressure differentials are suitable. For example, while an inert atmosphere may be maintained at the center of the reaction chamber, negative pressure may be imposed at the downstream end of the chamber to facilitate product collection in a continuous harvesting process.

There may be an electrolyte wash step in the process in three different instances: Washing may occur before delamination in the cell; washing may occur after delamination and followed by shredding; or washing may occur after shredding but before delamination.

The method can be conducted in completely dry phase. In another embodiment, alcohol or water may be utilized after the electrode material is subjected to a constituent separation process.

The method results in nearly 95 percent of original material being retained. Also, given the paucity of organic solvents, the chemical activity and physical characteristics of the separated electrode materials 24 and metal foils 26 are on par with virgin constituents.

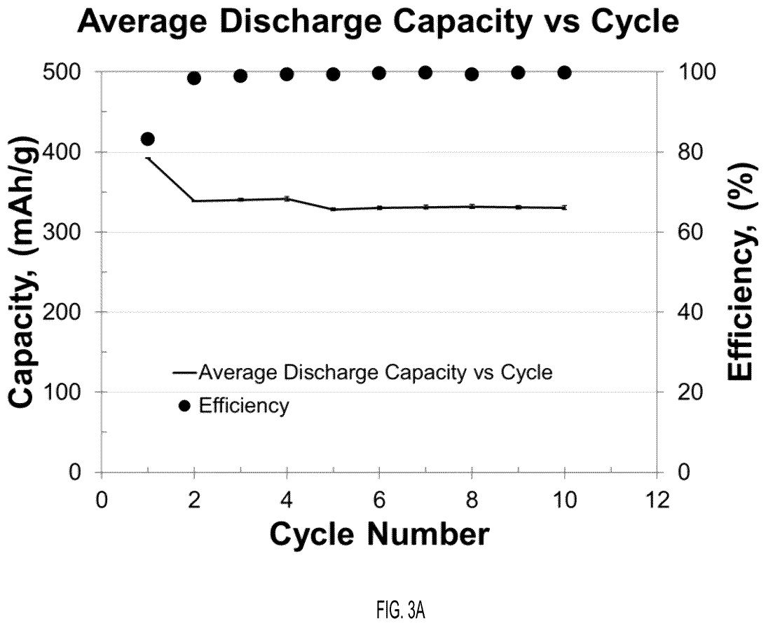

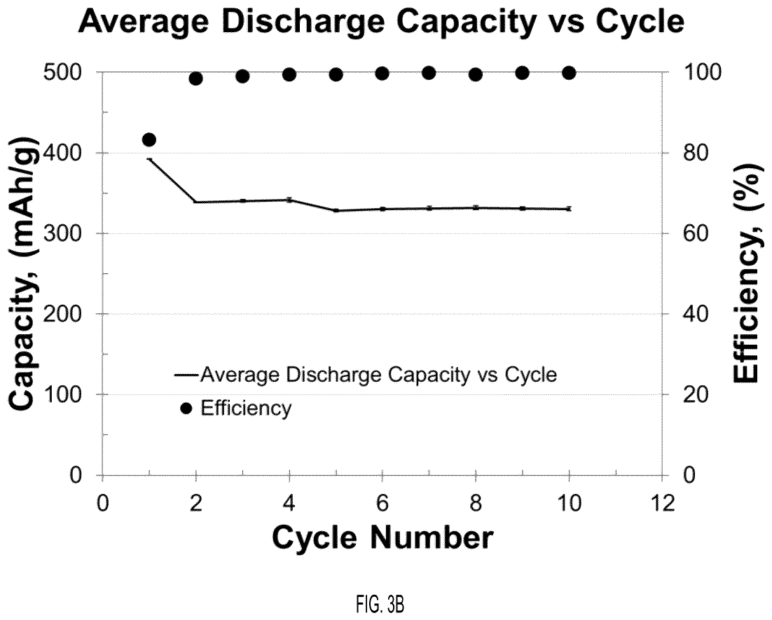

FIG. 3A is a graph showing average discharge capacity versus cycle of anode graphite regenerated with the instant continuous method. FIG. 3B is a graph showing average charge capacity versus cycle of anode graphite regenerated with the instant continuous method.

FIG. 4 is a schematic diagram of a continuous delamination method for spent battery active materials from current collectors. Specifically, FIG. 4 depicts a continuous feed induction heating reactor 28 with screw conveyor 34. The housing (conveyer cast) may be made of alumina or quartz. The conveyor may be made of graphite or other conductive material. This facilitates the positioning of the actual heating source (e.g., an induction heating coil 38) positioned outside of the reactor. While the coil is seen not contacting the exterior of the reactor 28, the coil may in some instances be in contact with the reactor.

Using this continuous reactor configuration, intact batteries may be placed therein. Induction heating may be applied to liberate full length current collector metals (e.g., copper strips). This delamination may be effected at temperatures of approximately 200° C. In this instance, electrodes are first shredded and then are contained within the housing wherein the inductive energy is applied to exterior surfaces of the housing. The housing maybe maintained at ambient temperature and pressure.

After delamination, both black mass and current collector metals pass through a means of egress 32. Then, the reactor may be heated to a temperature suitable to melt cathode current collector metals (e.g., aluminum), those metals subsequently leaving the reactor 28 via the means of egress 32.

The conveyor 34 may be actuated by a longitudinally extending shaft 40, (e.g., a screw conveyor) which spans the length of the reactor 28. The dotted lines shown in the figure depict the emf coils. The length of the dotted lines represent the extent of the hot zone. Generally, the reactor 28 may be confined or otherwise sequestered in a controlled atmosphere.

Intense heat is delivered to the interface of high conductive current collector foils and the less conductive active coating materials. The frequency of the electromagnetic radiation maybe selected from a wide range, for example from 100 Hz to 1000 kHz. The frequency can be fine-tuned depending on the constituents of the battery.

The application of the electromagnetic radiation which manifests as inductive heating causes a large temperature gradient. The gradient is established relatively quickly (within 0.01 to 100 seconds) compared to methods of heating utilized in state of the art battery recycling processes. The imposition of this sudden temperature gradient results in delamination of active coating materials, without having to increase the overall temperature of the materials substantially. The entire process, from application of inductive energy to delamination of material occurs between 2 and 10 minutes. The use of inductive energy results in energy savings of between $0.10 and $0.50 per kilogram of black mass regenerated.

The systems and methods of the present disclosure can include a direct recycling and method for recovery of electrodes of Li ion batteries (LIBs), more specifically, a cost-effective and fluid-free method for delamination of spent electrode materials from current collector strips of end of life Li ion batteries. The method can be applied for efficient high-throughput direct recycling of LIBs with better energy saving and improved greenhouse gas reduction.

When the process is performed on manufacturing scrap, the result is the generation of high purity electrode active materials and pristine (not-oxidized) current collector foils. Inasmuch as the reversible capacities of synthetic and natural graphite is 300 mAh/g and 330 mAh/g respectively, any reharvested graphite that displays capacities at or above 300 mAh/g is preferred.

The example below discusses the repurposing of LIB anode material, that material including active anode material (e.g., graphite) and metal current collector foil (copper). However, a myriad of battery constituents may be repurposed with the method, those constituents including, but not limited to cathode black mass material such as NMC, LCO. LFP, LNMO, LMO, anode black mass material such as Graphite, lithium, LTO, Si/C composites and current collectors selected from the group consisting of copper and alloys thereof, Al and alloys thereof, Ni and alloys thereof, Ti and alloys thereof, stainless steel, metalized polymer foil and graphite/carbon foil, and combinations thereof.

FIG. 2 is a photograph of shredded anode active materials after being subjected to inductive heating. FIG. 2 shows active anode coating materials and current collector Cu foils after delamination by induction heating processing. The electromagnetic frequencies utilized in these three separations ranged from 150 kHz/sec to 250 kHz/sec.

Table 1 shows the input mass versus recovered output mass in terms of grams. The respective weights and corresponding recovery ratios of the active material and foils are listed, wherein “Initial Wt” refers to weight of spent anode strips before inducting heating treatment. “Final Wt” refers to total remaining weight of spent anodes strips after induction heating treatment, “BM Wt” refers to weight of recovered black mass, and “CF Wt” refers to weight of recovered current collector Cu foils.

TABLE 1
Weights and recovery ratios of four samples of spent
anode delaminated by induction heating process:

| | | | | | Recov. |
|---|---|---|---|---|---|
| | Initial Wt | Final Wt | BM WT | CF Wt | Rate |
| Sample # | (g) | (g) | (g) | (g) | (%) |
| 1 | 3.01 | 2.91 | 1.96 | 0.94 | 94.69 |
| 2 | 3.05 | 2.95 | 2.18 | 0.77 | 95.61 |
| 3 | 3.02 | 2.94 | 2.02 | 0.90 | 95.28 |
| 4 | 3.01 | 2.92 | 2.21 | 0.71 | 96.09 |
| Average | 3.02 | 2.93 | 2.09 | 0.83 | 95.42 |

The recovered active anode materials accounted for approximately 95 percent of the total weight of the active coating materials on current collector foils. This compares with zero percent for state of the art pyro processes and 80 percent for hydrometallurgical processes.

Table 2 below shows the conductivity of recovered graphite generated by the recycling method, whereas Table 3 shows the performance of virgin materials.

Specifically, Table 2 shows the charge and discharge capacities for two samples of recovered electrode components, specifically graphite. P1 and P2 designate two samples generated by the method. Charge and discharge capacities are designated in milli-Amp hours per gram (mAh/g).

TABLE 2

| | | | | Standard |
|---|---|---|---|---|
| mAh/g | P1 | P2 | Average | Deviation |
| Reversible C Cap (mAh/g) | 333 | 333 | 333 | 0 |
| Reversible D Cap (mAh/g) | 338 | 339 | 339 | 0 |

Table 2 shows that the average reversible charging and discharging capacity for the recovered black mass is 333 mAh/g and 339 mAh/g, respectively. This compares to 345 mAh/g and 333 mAh/g of virgin material, thus evidencing a charge capacity of the recovered material that is 96.5 percent of the original.

Table 3 below shows the electrochemical performance of commercially available virgin graphite. Specifically, Table 3 shows the charging and discharging capacity of six different anode black mass materials. The half-cell voltage window (V) for this data was 1.5 to 0.0.

TABLE 3
Materials Screening Results

| | Reversible Charge Capacities at |
|---|---|
| Sample | C/10 (RT) (mAh/g) |
| 1-Natural Graphite | 345 |
| 2-Natural Graphite | 262 |
| 3-Artificial Graphite | 336 |
| 4-Natural Graphite | 326 |
| 5-Artificial Graphite | 306 |
| 6-Artificial Mesocarbon Microbeads | 306 |

All of the six samples are commercially available. Specifically, samples 1 and 2 were natural graphite and experimental graphite from Phillips, Samples 3 and 5 were artificial graphite from Hitachi, Sample 4 was natural graphite from Superior Graphite (Chicago), and Sample 6 was artificial mesocarbon microbeads carbon from Gelon (ShanDong, China).

Among other embodiments, a method for reclaiming electrodes from intact batteries is provided, the method including discharging the intact batteries, positioning the discharged intact batteries into a reactor, the reactor defining a first housing, separating components of the electrodes while the electrodes reside within the housing, and removing the separated components from the housings. The separated components include metallic current-collectors and the metallic current collectors are removed still intact. The separating step includes heating solely the surfaces of the washed electrodes to between 18° and 250° C.

The process utilizes a no contact heating method such as the imposition of inductive energy. The inductive energy is applied to exterior surfaces of the housings. This no contact heating feature allows separation occurs at ambient temperature and pressure. As such, the step of separation includes heating only the surfaces of the electrodes. This step of delamination includes delivering energy at the interface of current collectors and active electrode materials, without physically contacting the current collectors and active materials.

The batteries typically would contain electrolyte materials selected from the group consisting of polar solvent, non-polar solvent, and a combination thereof. However, intact manufacturing scrap may not contain electrolyte.

The present disclosure includes a method for direct recycling of electrodes, such as anodes and cathodes. A feature of the method is that no organic solvents are required. An advantage of the method is the minimization of secondary waste streams.

The method provides a recycling material for incorporation into electrodes for lithium ion batteries (LIBs). The recovered material has 95-98 percent of the material performance of virgin active material. An advantage is the expansion of overall feedstock in the market for this active material, therefore ameliorating the reliance on foreign sources of certain minerals such as graphite, cobalt, nickel, and lithium. Another advantage is the diversion of heretofore spent LIBs from landfills.

A method for recovering active material from current collectors from the electrodes of spent LIBs is provided. A feature of the method is the use of induction heating to delaminate the active material from the current collectors. An advantage is that it is performed at temperatures no higher than 250° C., rather between 12° and 250°-C., and preferably between 150° C. and 250° C.

The method can provide a completely dry process for harvesting black mass and current collectors from intact, end-of-life batteries. A feature is that only the surfaces of the battery casing and of the electrodes are heated. An advantage is that it yields primarily nonpartitioned (i.e., intact) current collectors and reusable black mass. As such, the method provides a nondestructive method for harvesting electrode components for direct reuse.

A method for recycling electrodes is provided. The method include inductively heating the electrodes for a time sufficient to delaminate active material from current collectors underlying the active material. The process utilizes high frequency induction heating, which is a form of noncontact heating generated by the application of an electromagnetic field. The process can be performed in ambient temperatures and pressures and in non-oxidizing atmospheres such as N₂, Ar, and He.

An embodiment of the method includes reclaiming electrodes from intact EOL (e.g., spent) batteries and electrode manufacturing scraps, the method includes discharging the EOL batteries, and inductively separating components of the electrodes, wherein metallic components comprising current collectors of the electrodes maintain their original manufactured dimensions. The recovery of originally dimensioned current collectors, (wherein the metallic foils are not cut, mutilated or otherwise broken apart) enhances the value of the method, compared to one of the state-of-the-art systems wherein collectors are melted. Preferably, the intact batteries recycled here are devoid of organic electrolyte, such that any such electrolyte is first removed. In instances where electrodes include copper foil laminated with graphite, no shredding is required. These instances mainly dealt with manufacturing scraps, as noted above.

Another embodiment of the method includes discharging the electrodes, transforming the discharged electrodes into smaller but still laminated pieces; optionally washing the pieces, and then separating each of the components (e.g., current collectors, active materials, binder, and carbon black) of the pieces. The transforming step may include comminution such as shredding. This shredding step is often already accomplished inasmuch as spent battery feedstocks are usually shredded prior to separation procedures.

The method also provides recovered active material derived from spent lithium ion batteries. The material is recovered via a direct recycling method to yield black mass retaining 95-100 percent of its original performance targets.

A method for reclaiming active material and current collectors from electrodes includes heating only surfaces of the active material which oppose surfaces of the current collectors for a time sufficient to delaminate the active material from the current collectors.

The disclosure also provides a system for separating active material from current collectors of electrodes, the system comprising a particle transport mechanism enclosed in a housing; a first entry port for inserting electrodes into the housing and a second entry port for removing electrode components from the housing; and a no contact means for heating only surfaces of the active material which oppose surfaces of the current collectors. An exemplary no contact means is an inductive energy generator.

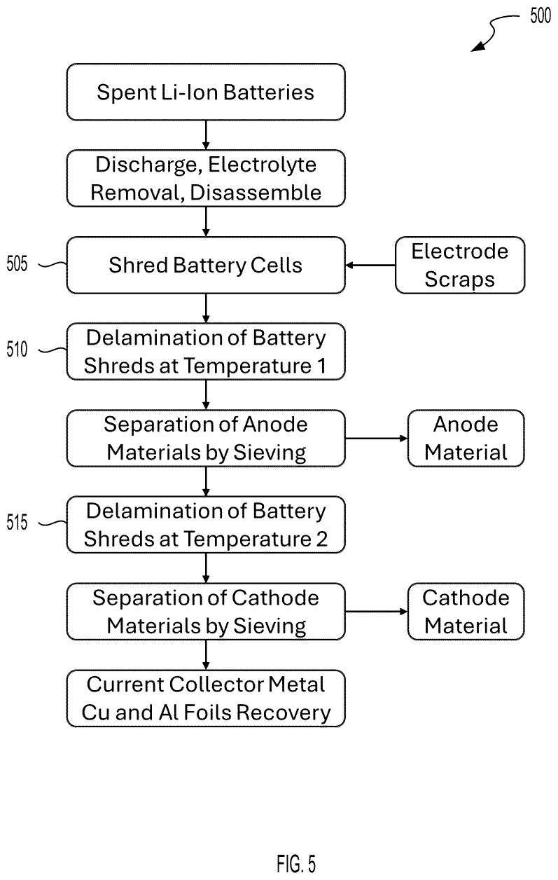

FIG. 5 illustrates a schematic flow diagram of a method 500 for recovery of active electrode materials from spent LIBs by induction heating. The method includes collecting spent LIBs, discharging, removal of electrolyte, and disassembling, followed by shredding battery cells. Afterwards, the shreds, which contain both anode materials coated copper foil current collectors and cathode materials coated aluminum foil current collectors, are subjected to the first heat-treatment in induction heating system at a lower temperature, and separation of active anode materials. This step recovers the active anode materials (graphite) from the feedstock shreds. Then the remaining materials in feedstock shreds, which contain cathode materials coated current collector Al foils and delaminated anode current collector Cu foils, undergo the second heat-treatment in induction heating system at a higher temperature. This process utilizes induction heating, which is an effective noncontact heating by electromagnetic field. This process delivers the heating energy right at the interface of current collectors and the active electrode (anode and cathode) materials coated on respective current collector foils, allows fast heating of the materials locally at the interface, and thus effectively resulting in delamination of active anode material from its current collectors first via induction heat treatment 1 (at a lower temperature 1), and subsequent delamination of active cathode material from its current collectors via induction heat treatment 2 (at a higher temperature 2). Induction heat treatment does not require solvents or any other types of fluid in the delamination process. Heating energy is effectively delivered via electromagnetic field to the interface of electrodes and their respective current collector metal foils. When combined with inert atmosphere, high purity spent active electrode materials, and pristine (not-oxidized) current collector metal foils can be recovered. The method 500 can include delaminating electrodes.

The method 500 can include providing a feedstock (BLOCK 505). The feedstock can include shredded battery cells and/or electrode scraps (e.g., anode scraps 18, cathode scraps). The feedstock can include spent batteries (e.g., Li-ion batteries). The spent batteries can be discharged, the electrolyte can be removed, and then the batteries can be disassembled. The feedstock can be disposed in a battery cell. The feedstock can include a first active material disposed on a first current collector. The first current collector can include copper. The feedstock can include a second active material disposed on a second current collector. The second current collector can include aluminum. The feedstock can be disposed in a housing and the housing can be maintained at ambient temperature and pressure.

In one embodiment, the feedstock can include an anode that include the first active material disposed on the first current collector. The feedstock can include a cathode that includes the second active material disposed on the second current collector. In another embodiment, the feedstock can include a cathode that include the first active material disposed on the first current collector and an anode that include the second active material disposed on the second current collector.

The method 500 can include heating the feedstock above a first temperature (BLOCK 510). For example, the method 500 can include heating, by induction, the feedstock above a first temperature for a first period of time. The first temperature can be in a range between 180° C. and 220° C. For example, the first temperature can be in a range between 180° C. and 200° C., 180° C. and 220° C., or 200° C. and 220° C. The first active material is configured to delaminate from the first current collector during the first period of time. The first period of time can be in a range between 1 second and 2 minutes. The induction heating can occur at a frequency above 100 kHz. The method 500 can include delaminating the first active material from the first current collector. For example, the method 500 can include delaminating the first active material from the first current collector by heating the feedstock above the first temperature during the first period of time. The first active material can be delaminated from the first current collector for a portion of the first period of time. The first active material can start to delaminate from the first current collector when the feedstock reaches a temperature above the first temperature.

The method 500 can include heating the feedstock above a second temperature (BLOCK 515). For example, the method 500 can include heating, by induction, the feedstock above a second temperature for a second period of time. The second period of time can be subsequent to the first period of time. The second temperature is greater than the first temperature. The higher temperature can be applied after the lower temperature. The second temperature can be in a range between 380° C. and 420° C. For example, the second temperature can be in a range between 380° C. and 400° C., 380° C. and 420° C., or 400° C. and 420° C. The second active material is configured to delaminate from the second current collector during the second period of time. The second period of time can be in a range between 1 second and 2 minutes. The second period of time can be greater than, less than, or equal to the first period of time. The induction heating can occur at a frequency above 100 kHz. The method 500 can include delaminating the second active material from the second current collector. For example, the method 500 can include delaminating the second active material from the second current collector by heating the feedstock above the second temperature during the second period of time. The second active material can be delaminated from the second current collector for a portion of the second period of time. The second active material can start to delaminate from the second current collector when the feedstock reaches a temperature above the second temperature.

The method 500 can include separating the first current collector and the second current collector from the first active material and the second active material. The method 500 can include separating the first current collector from the first active material after heating the feedstock above the first temperature. In one example, delaminating the first current collector from the first active material occurs after heating the feedstock above the first temperature. Before reaching the first temperature, the first active material and the first current collector may be laminated. The method 500 can include separating the second current collector from the second active material after heating the feedstock above the second temperature. In one example, delaminating the second current collector from the second active material occurs after heating the feedstock above the second temperature. Before reaching the second temperature, the second active material and the second current collector may be laminated. The method 500 can include separating the anode materials by sieving. The method 500 can include separating the cathode materials by sieving.

The method 500 can provide for delamination of electrode (both anode and cathode) materials from current collector strips/foils. The recovery rate for active materials can be greater than 95%. High purity (e.g., no oxidation) current collectors (e.g., Al and Cu) strips can be recovered. The method 500 can include recovering the current collector metals/foils.

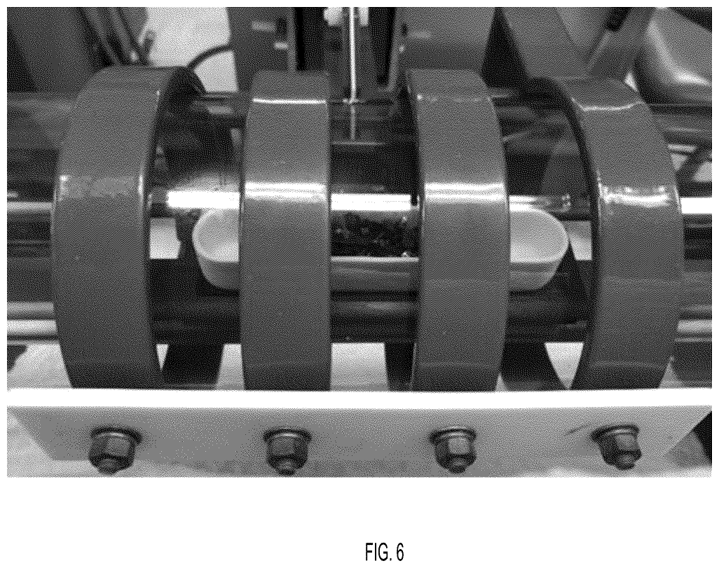

FIG. 6 is an image of shredded anode strips in an alumina boat loaded into an induction heating system for processing. Electromagnetic field used for generating eddy current in conducting materials can be applied instantaneously. The spent anode materials can be heated up in seconds. Intense heat delivered to the interface of high conductive current collector foils and the less conductive active coating materials causes them to be subjected to a large temperature gradient suddenly and therefore result in delamination of active anode coating materials without having to increase the overall temperature of the materials substantially. Because of the large mismatch in CTEs between the anode material and copper current collector foils, induction heating at relatively low temperature (˜200° C.) can effectively delaminate and separate anode coating materials from Cu current collector foils. Because of smaller difference in CTEs between cathode materials and Al current collector foils, delamination and separation of active cathode materials from Al foils can occur at higher interfacial temperature (˜400° C.) but still substantially below the melting temperature of aluminum. Cathode coating materials can be recovered by induction heating without alternation of their chemical compositions. This process can be adapted to a continuous process.

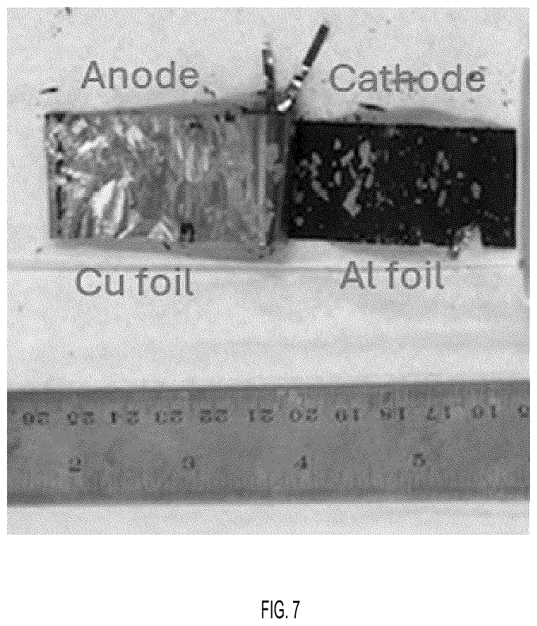

FIG. 7 is an image of the remaining metal foils (anode and cathode current collector foils) after delamination and removal anode and cathode materials by the induction heating delamination process. Some cathode coating materials are still affixed onto the aluminum foils as shown.

A system of the present disclosure can include a reactor. The reactor can include a conveyor (e.g., conveyor 34) disposed in a housing. The system can include a first port (e.g., fluid ingress port 30). The first port can be coupled with the housing and configured to receive the feedstock. The feedstock can include the first active material disposed on the first current collector and the second active material disposed on the second current collector. The first current collector and the second current collector can be separated from the first active material and the second active material. The first current collector can include copper. The second current collector can include aluminum.

The system can include a first induction heater. The first induction heater can be disposed around the housing downstream of the first port. The first induction heater can be configured to delaminate the first active material from the first current collector by heating the feedstock above the first temperature for the first period of time.

The system can include a second induction heater. The second induction heater can be disposed around the housing downstream of the first induction heater. The second induction heater can be configured to delaminate the second active material from the second current collector by heating the feedstock above the second temperature for the second period of time. The second temperature is greater than the first temperature.

The system can include a second port (e.g., egress 32) coupled with the housing downstream of the second induction heater. The second port configured to remove the feedstock from the housing.

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed:

1. A method, comprising:
providing a feedstock comprising a first active material disposed on a first current collector and a second active material disposed on a second current collector;
heating, by induction, the feedstock above a first temperature for a first period of time;
delaminating the first active material from the first collector during the first period of time;
heating, by induction, the feedstock above a second temperature, which is greater than the first temperature, for a second period of time subsequent to the first period of time; and
delaminating the second active material from the second current collector during the second period of time.

2. The method of claim 1, comprising:
separating the first current collector and the second current collector from the first active material and the second active material.

3. The method of claim 1, wherein delaminating the first current collector from the first active material occurs after heating the feedstock above the first temperature.

4. The method of claim 1, wherein delaminating the second current collector from the second active material occurs after heating the feedstock above the second temperature.

5. The method of claim 1, wherein the first current collector comprises copper.

6. The method of claim 1, wherein the second current collector comprises aluminum.

7. The method of claim 1, wherein the first temperature is in a range between 180° C. and 220° C.

8. The method of claim 1, wherein the second temperature is in a range between 380° C. and 420° C.

9. The method of claim 1, wherein the feedstock is disposed in a battery cell.

10. The method of claim 1, wherein:
the first period of time is in a range between 1 second and 2 minutes, and
the second period of time is in a range between 1 second and 2 minutes.

11. The method of claim 1, wherein the feedstock comprises:
an anode comprising the first active material disposed on the first current collector, and
a cathode comprising the second active material disposed on the second current collector.

12. The method of claim 1, wherein the feedstock comprises:
a cathode comprising the first active material disposed on the first current collector, and
an anode comprising the second active material disposed on the second current collector.

13. The method of claim 1, wherein the feedstock is disposed in a housing and the housing is maintained at ambient temperature and pressure.

14. The method of claim 1, wherein the induction heating occurs at a frequency above 100 kHz.

15. A system, comprising:
a reactor comprising a conveyor disposed in a housing;
a first port coupled with the housing and configured to receive a feedstock comprising a first active material disposed on a first current collector and a second active material disposed on a second current collector;
a first induction heater disposed around the housing downstream of the first port; and
a second induction heater disposed around the housing downstream of the first induction heater.

16. The system of claim 15, comprising:
a second port coupled with the housing downstream of the second induction heater and configured to remove the feedstock from the housing.

17. The system of claim 15, wherein:
the first induction heater is configured to delaminate the first active material from the first current collector by heating the feedstock above a first temperature for a first period of time,
the second induction heater is configured to delaminate the second active material from the second current collector by heating the feedstock above a second temperature for a second period of time, and
the second temperature is greater than the first temperature.

18. The system of claim 15, wherein the first current collector and the second current collector are separated from the first active material and the second active material.

19. The system of claim 15, wherein the first current collector comprises copper.

20. The system of claim 15, wherein the second current collector comprises aluminum.
